(19) United States
(12) Patent Application Publication
(10) Pub. No.: US 2026/0228858 A1
(43) Pub. Date: Aug. 6, 2026

(54) OBJECT-AWARE EXPOSURE FUSION OF IMAGES

(71) Applicant: QUALCOMM Incorporated, San Diego, CA (US)

(72) Inventors: Yuqi Ding, Santee, CA (US); Narayana Karthik Ravirala, San Diego, CA (US); Shizhong Liu, San Diego, CA (US)

(21) Appl. No.: 19/044,313

(22) Filed: Feb. 3, 2025

(51) Int. Cl. G06T 5/50; G06T 5/20; G06T 5/92; G06T 7/10; G06T 7/90; G06V 10/60

(52) U.S. Cl. CPC G06T 5/50; G06T 5/20; G06T 5/92; G06T 7/10; G06T 7/90; G06V 10/60; G06T 2207/10144; G06T 2207/20016; G06T 2207/20221

(57) ABSTRACT

This disclosure provides systems, methods, and devices that perform object-aware guided exposure fusion for tone mapping high dynamic range (HDR) images to lower dynamic range images. In one aspect, a method is provided that includes receiving a first image frame and generating a plurality of second image frames, each corresponding to an exposure value that differs from the first image frame. The method further includes determining segmentation maps of objects within the first image frame and computing exposure scores for image regions defined by the segmentation maps in each second image frame, such as based on deviation of intensity levels from a reference intensity level. Weights are determined based on these scores, and an output image is generated by combining the second image frames using guided multi-scale image fusion. Fusion may incorporate pyramid decomposition techniques and guided filtering. Other aspects are provided.

### TECHNICAL FIELD

Aspects of the present disclosure relate generally to image processing, and more particularly, to exposure fusion techniques. Some features may enable and provide improved image processing, including by providing object aware exposure fusion techniques.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

Dynamic range may be important to image quality when capturing a representation of a scene with a wide color gamut using an image capture device. Conventional image sensors have a limited dynamic range, which may be smaller than the dynamic range of human eyes. Dynamic range may refer to the light range between bright portions of an image and dark portions of an image. A conventional image sensor may increase an exposure time to improve detail in dark portions of an image at the expense of saturating bright portions of an image. Alternatively, a conventional image sensor may decrease an exposure time to improve detail in bright portions of an image at the expense of losing detail in dark portions of the image. Thus, image capture devices conventionally balance conflicting desires, preserving detail in bright portions or dark portions of an image, by adjusting exposure time. High dynamic range (HDR) photography improves photography using these conventional image sensors by combining multiple recorded representations of a scene from the image sensor.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure provides object-aware guided exposure fusion techniques for tone mapping images, such as tone mapping high dynamic range (HDR) images to lower dynamic range suitable for display devices. These techniques may integrate semantic segmentation and guided filtering into the exposure fusion process to enhance visual quality and preserve details across multiple luminance levels. By generating multiple virtual exposure images from a single HDR image, these techniques can select the best exposure images based on object-specific exposure scores derived from semantic segmentation masks. An enhanced weight map may computed, incorporating multiple factors such as contrast, saturation, exposure quality, saliency, categorical weights, or combinations thereof. A guided multi-scale image fusion process may then be applied to produce the final LDR image with reduced artifacts and improved detail preservation.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3A depicts a system for guided exposure fusion according to some embodiments of the disclosure.

FIG. 3B depicts a plot of exemplary tone mapping curves according to one aspect of the present disclosure.

FIG. 3C depicts a scenario in which segmentation maps are determined for a received image according to one aspect of the present disclosure.

FIG. 3D depicts a scenario in which a plurality of scores are determined for a segmentation map according to one aspect of the present disclosure.

FIG. 3E depicts plots of scores according to one aspect of the present disclosure.

FIG. 4 shows a flow chart of an example method for processing image data to guided exposure fusion according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In digital imaging, accurately capturing and displaying scenes with a high dynamic range (HDR) is challenging due to the limitations of standard display devices, which typically support only lower dynamic range (LDR) formats. For example, HDR images may be captured with 8 orders of magnitude or between the minimum and maximum brightness, while displays may be less capable (such as 4 orders of magnitude, 2 orders of magnitude). Thus, while HDR imaging techniques can capture detailed images across a wide range of brightness levels, directly scaling these images to fit the LDR range often results in significant loss of detail, particularly in shadow and highlight regions.

Therefore, effective tone mapping algorithms are required to convert HDR images into LDR formats suitable for display while preserving visual quality. Tone mapping may be performed to map the pixel values of an HDR image to accommodate the limited dynamic range of display devices. This can involve compressing a wide range of luminance levels in the HDR image into a narrower range of the display while attempting to maintain perceptual image quality. Traditional tone mapping methods can be broadly categorized into global tone mapping, which applies a single non-linear mapping curve to all pixels in the image uniformly, and local tone mapping, adjusts the mapping curve based on local image characteristics around particular pixels or image regions.

Existing tone mapping methods face several limitations. For example, conventional tone mapping techniques may emply linear transformations that directly scale HDR images, but can lead to a loss of important visual information. Traditional non-linear tone mapping approaches, such as global and local tone mapping, may apply mapping curves to adjust the intensity of HDR images. However, these methods may result in reduced image quality, including loss of local contrast and the introduction of visual artifacts like halos or unnatural contrasts.

Exposure fusion techniques have been developed to address some of these challenges by merging multiple images captured or generated at different exposure levels. However, exposure fusion methods may still encounter issues such as pixel values exceeding the displayable range and halo effects around high-contrast edges, which can degrade the overall visual quality of the image.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

One solution to this problem is to integrate semantic segmentation and guided filtering into the exposure fusion process to create an object-aware method for tone mapping. To do so, the present techniques propose generating multiple virtual exposure images from a single HDR image using a novel curve equation that adjusts pixel intensities based on controllable parameters. By applying semantic segmentation, these techniques support identifying and labeling different objects or regions within the scene. In addition, the techniques may apply different tone mapping curves to an HDR image to generate images with different exposure levels.

These techniques compute exposure scores for each object in the segmented images to determine which of the image(s) best represent each object. By selecting the best exposure images for each object based on these scores, the present techniques prioritize important regions within the scene. An enhanced weight map may then be calculated for the images, incorporating multiple factors such as contrast, saturation, exposure quality, saliency, categorical weights, or combinations thereof.

A guided multi-scale image fusion process may then applied that using guided filtering on the weight maps with the luminance channel. This approach to fusion may preserve edges and reduces artifacts by smoothing the weights while maintaining important structural information. The fused image may then be reconstructed from the multi-scale representations, resulting in an output image with improved detail preservation and visual quality that can be displayed on lower dynamic range displays.

Particular implementations of the subject matter described in this disclosure may be implemented to realize one or more of the following potential advantages or benefits. In some aspects, the present disclosure provides techniques for object-aware guided exposure fusion that may be particularly beneficial in tone mapping high dynamic range images to low dynamic range formats suitable for display devices. For example, by intelligently selecting exposure images based on semantic segmentation and object-specific exposure scores, these techniques ensure that important objects within the scene are optimally exposed and visually prominent, improving image quality.

These techniques may improve image quality by incorporating guided filtering in the multi-scale fusion process, which helps preserve fine details and reduces artifacts such as halos and out-of-range pixel values. This results in a natural-looking image with balanced exposure and enhanced detail across various luminance levels, improving image quality.

For end users, these improvements may enhance the visual experience by providing images with greater detail, contrast, and realism. Additionally, the ability to adjust parameters such as curve equation variables and weighting factors allows users to personalize the image processing to suit their preferences. Additionally, generating multiple exposures from a single HDR image may improve computational efficiency and reduce resource utilization, making these techniques suitable for real-time applications in devices like mobile phones and digital cameras without the need for further processing multiple exposures or capturing multiple exposures.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

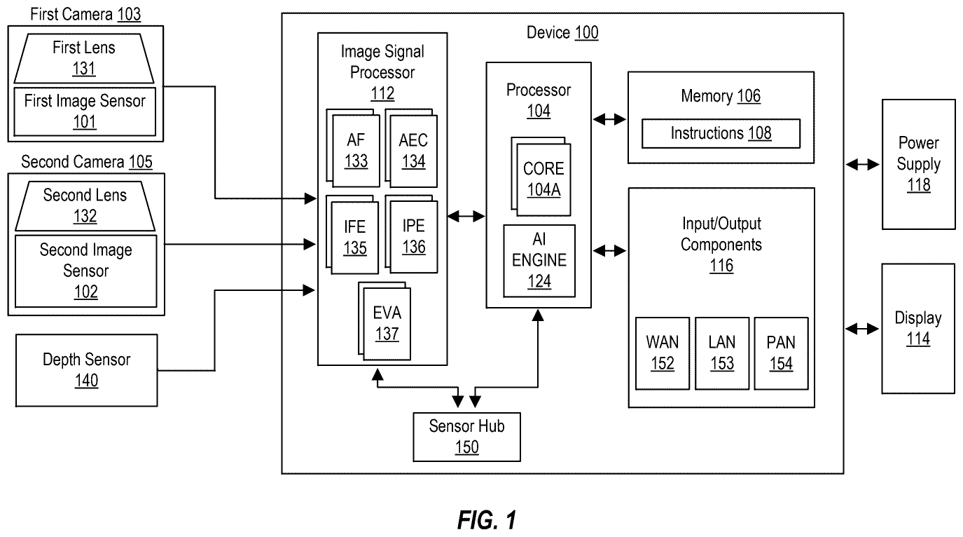

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The camera 103 may have different characteristics based on the current aperture size, such as a different depth of focus (DOF) at different aperture sizes.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), one or more auto exposure compensation (AEC) 134 engines, and/or one or more engines for video analytics (EVAs). The AF 133, AEC 134, IFE 135, IPE 136, and EVA 137 may each include application-specific circuitry, be embodied as software code executed by the ISP 112, and/or a combination of hardware and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including object aware exposure fusion operations. For example, execution of the instructions can instruct the image signal processor 112 to begin or end capturing an image frame or a sequence of image frames, in which the capture includes object aware exposure fusion as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

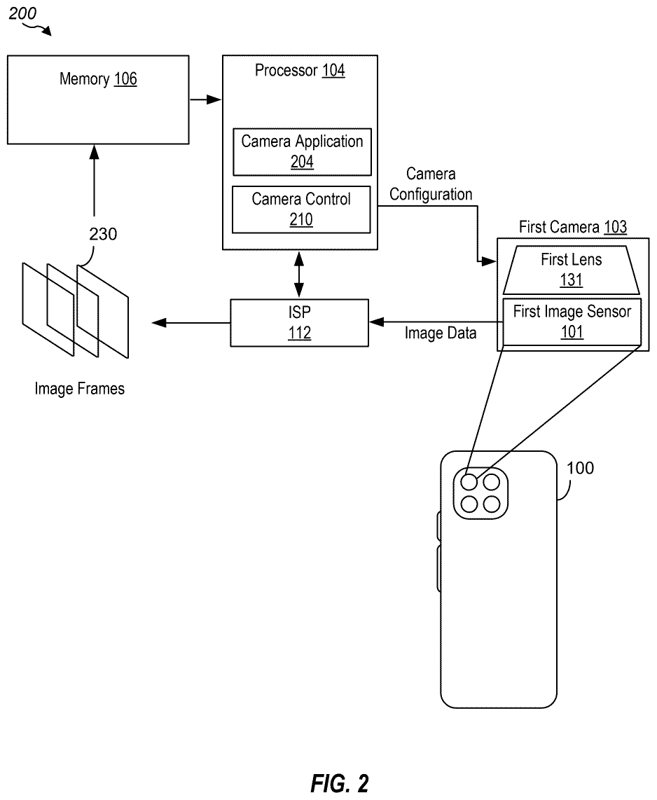

The exemplary image capture device of FIG. 1 may be operated to obtain improved images by performing exposure fusion using object aware segmentation maps. One example method of operating one or more cameras, such as camera 103, is shown in FIG. 2 and described below.

FIG. 2 is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as for configuring the camera 103 through a driver executing on the processor 104. The camera control 210 may be managed by a camera application 204 executing on the processor 104, which provides settings accessible to a user such that a user can specify individual camera settings or select a profile with corresponding camera settings. The camera control 210 communicates with the camera 103 to configure the camera 103 in accordance with commands received from the camera application 204. The camera application 204 may be, for example, a photography application, a document scanning application, a messaging application, or other application that processes image data acquired from camera 103.

The camera configuration may parameters that specify, for example, a frame rate, an image resolution, a readout duration, an exposure level, an aspect ratio, an aperture size, etc. The camera 103 may obtain image data based on the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

In some embodiments in which camera 103 is a variable aperture (VA) camera system, the processor 104 may execute a camera application 204 to instruct camera 103 to configure to a first aperture size, obtain first image data from the camera 103, instruct camera 103 to configure to a second aperture size, and obtain second image data from the camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 is a larger aperture size than f/8.0.

The image data received from camera 103 may be processed in one or more blocks of the ISP 112 to form image frames 230 that are stored in memory 106 and/or provided to the processor 104. The processor 104 may further process the image data to apply effects to the image frames 230. Effects may include Bokeh, lighting, color casting, and/or high dynamic range (HDR) merging. In some embodiments, functionality may be embedded in a different component, such as the ISP 112, a DSP, an ASIC, or other custom logic circuit for performing the additional image processing.

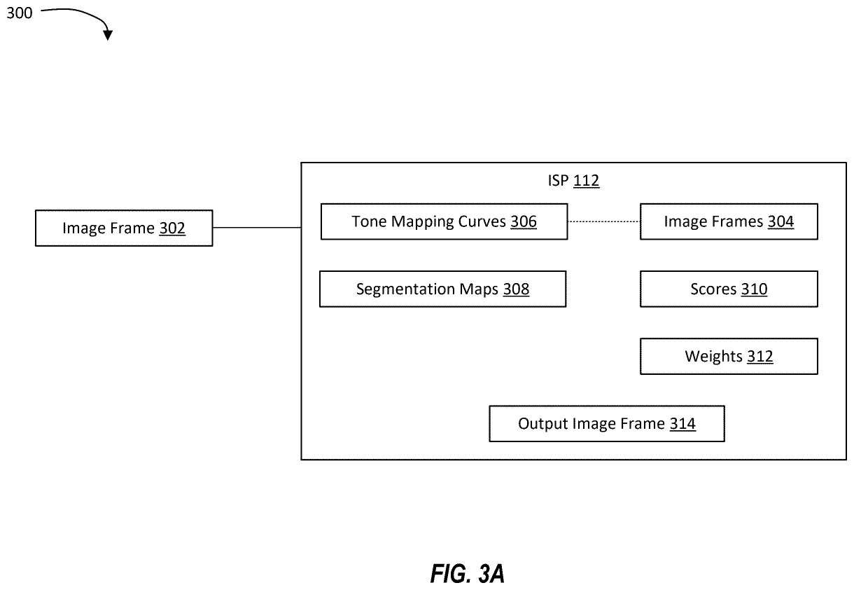

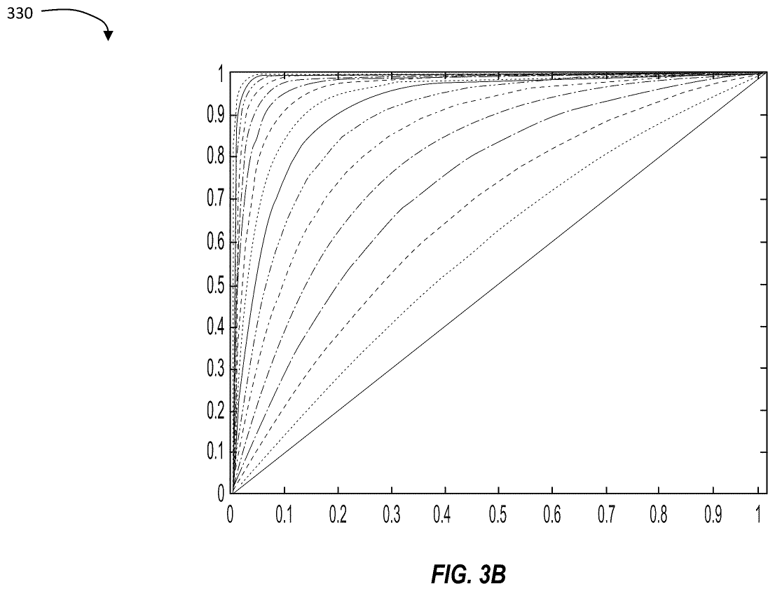

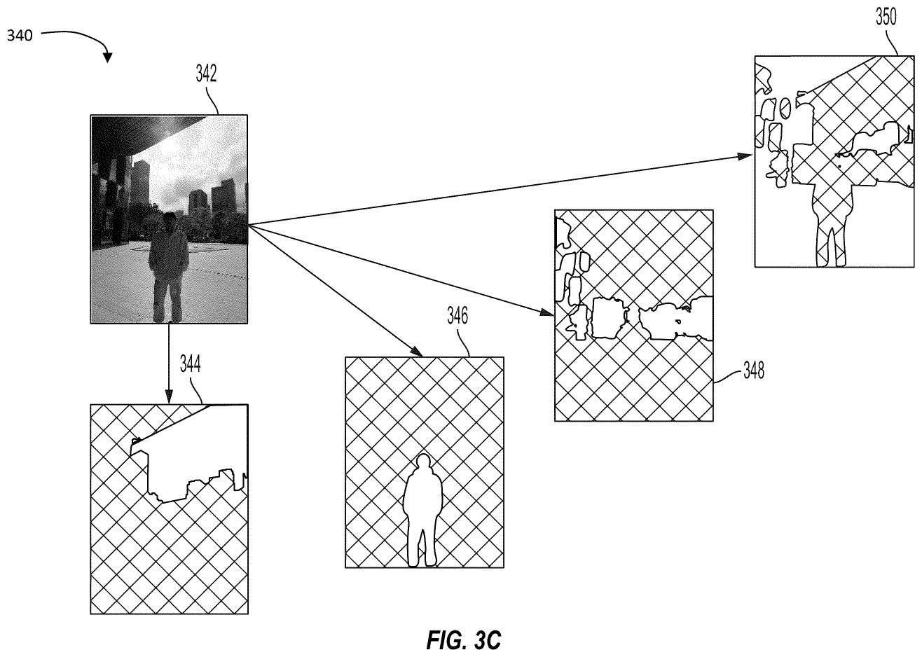

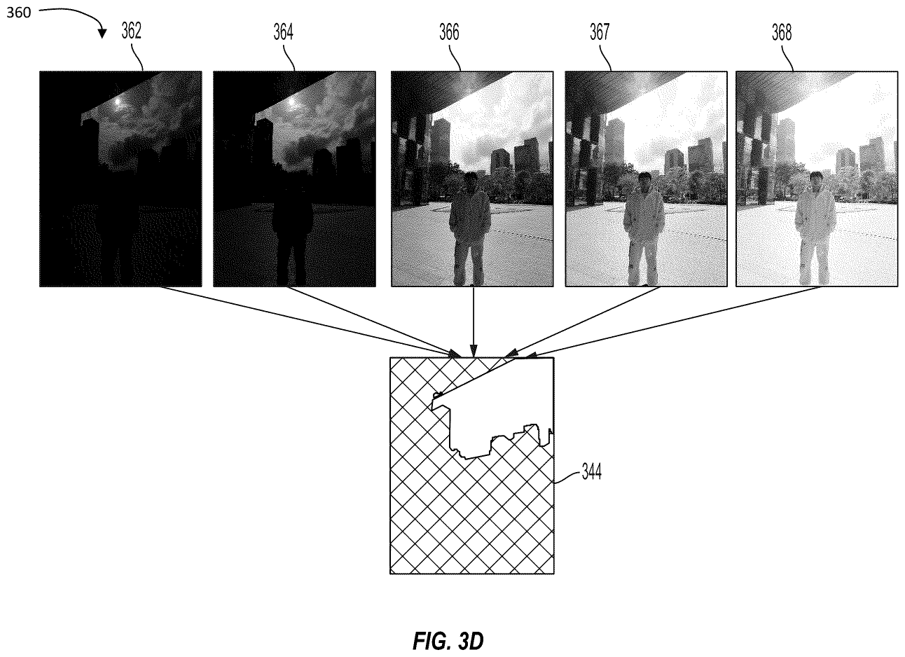

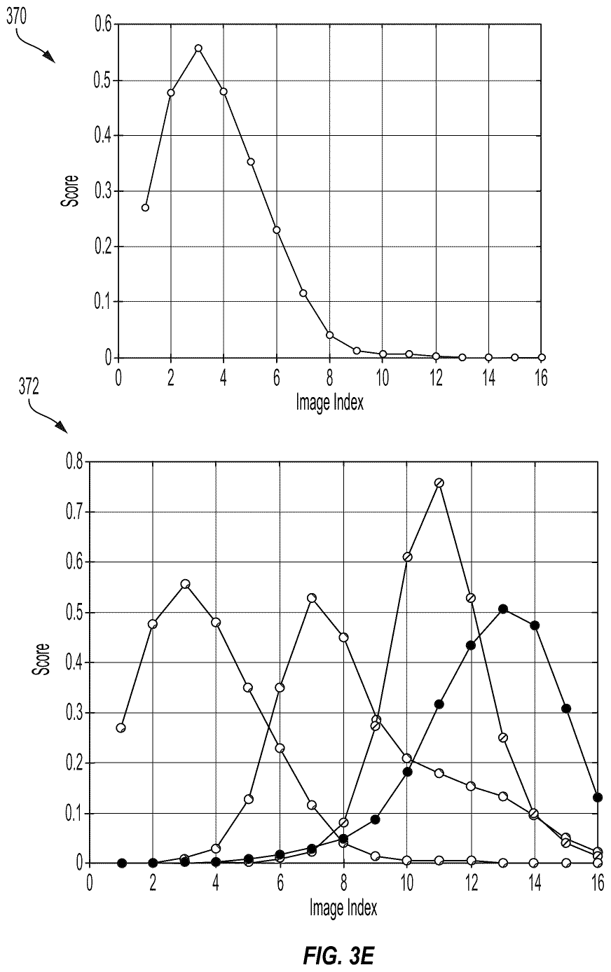

For example, FIG. 3A depicts a system 300 for object aware exposure fusion according to some embodiments of the disclosure. The system 300 includes a first image frame 302 and the ISP 112. The ISP 112 includes second image frames 304, tone mapping curves 306, segmentation maps 308, scores 310, weights 312, and an output image 314.

The ISP 112 may be configured to receive a first image frame 302. The first image frame 302 may be a digital image obtained by an imaging device, such as the camera 103 or another device coupled to the system 300. In certain implementations, the first image frame 302 may be captured in real-time by the image sensor 101 using the lens 131, or may be retrieved from storage, such as the memory 106, where the image has been previously stored. In some implementations, the first image frame 302 may be an HDR image frame. For example, an HDR image may represent luminance values across 20 bits per color channel, providing greater dynamic range compared to 8-bit images commonly used in LDR formats.

In certain implementations, the ISP 112 may be configured to generate a plurality of second image frames 304. Each second image frame 304 may correspond to a different exposure level of the first image frame 302. In particular, each of the second image frames may correspond to a respective second exposure value that differs from a first exposure value of the first image frame. Generating the second image frames 304 may involve simulating different exposure levels by applying various transformations to the first image frame 302 rather than capturing multiple images at different exposures. Simulating different exposure levels may be beneficial in scenarios where capturing multiple exposures is impractical due to motion or processing constraints.

Generating the plurality of second image frames 304 may involve applying a plurality of tone mapping curves 306 to the first image frame 302. Each tone mapping curve 306 may define a specific mapping of input pixel intensities to output pixel intensities, resulting in a second image frame 304 with a particular exposure level. The tone mapping curves 306 may be selected or otherwise configured to emphasize different luminance ranges within the first image frame 302. In certain implementations, at least a subset of the tone mapping curves 306 may be determined as:

$${x}_{output} = {x}_{input} - α ( {x}_{input}^{p} - {x}_{input} )$$

where
xᵢₙₚᵤₜ represents the input pixel intensity from the first image frame 302,
a is a scaling factor that controls the strength of the curve applied to the pixel intensity, and
p is a power exponent that shapes the curvature of the tone mapping function.

By varying the parameters a and p, different tone mapping curves may be generated, producing second image frames 304 with various exposure characteristics. For example, FIG. 3B depicts a plot 330 of exemplary tone mapping curves according to one aspect of the present disclosure with different parameters that may each be used to determine separate second image frames 304. In particular, choosing different values for a may control the degree of adjustment applied to mid-tone intensities, while varying p may affect the emphasis on shadows or highlights. The use of varying a and p allows the ISP 112 to create multiple second image frames 304 that simulate images captured at different exposure levels without requiring multiple physical captures. In certain implementations, typical values for a may range between 0 and 1, such as 0.2, 0.5, or 0.8, while typical values for p may range from 1 to 5, such as 1, 2, 3, or 4. For example, using a=0.5 and p=2 may enhance mid-tones and overall brightness, whereas a=0.8 and p=3 may emphasize details in the shadows.

In certain examples, the tone mapping curves 306 may be applied to the luminance component of the first image frame 302. For example, the ISP 112 may extract the luminance values from the first image frame 302 and apply the tone mapping curves 306 to generate modified luminance values for each second image frame 304. The chrominance components may remain unchanged or may be adjusted consistently with the luminance transformation.

In certain implementations, the plurality of second image frames 304 may simulate differently exposed images without the need for multiple captures. The ability to simulate differently exposed images without multiple captures may be advantageous in dynamic scenes where capturing multiple exposures could result in motion artifacts. By generating the second image frames 304 from the first image frame 302, the system 300 may accordingly maintain temporal consistency and reduce processing overhead, while still allowing for improved tone mapping of HDR images.

The ISP 112 may be configured to determine a plurality of segmentation maps 308 based on the first image frame 302.11. In certain implementations, the segmentation maps 308 may be determined before, after, or in parallel with determining the second image frames 304. For example, the ISP 112 may first generate the segmentation maps 308 may then determine the second image frames 304. As another example, the ISP 112 may determine the segmentation maps 308 and the second image frames 304 simultaneously by processing the first image frame 302 through separate parallel processing pipelines.

In certain implementations, the segmentation maps 308 correspond to different regions or objects within the first image frame 302. For example, each segmentation map 308 may define image regions by assigning pixels to particular regions or objects. In certain implementations, the ISP 112 may analyze the first image frame 302 to assign object labels to pixels within the image. Each label may represent one of a plurality of objects present in the scene. For example, the ISP 112 may identify objects such as “sky,” “building,” “vegetation,” or “person” within the first image frame 302. The segmentation maps 308 may be determined based on the assigned labels for each pixel or image region, resulting in separate maps for each identified object. For example, FIG. 3C depicts a scenario 340 in which segmentation maps 344, 346, 348, 350 are determined for a received image 342 according to one aspect of the present disclosure.

In certain implementations, determining the segmentation maps 308 may involve using a machine learning model trained to perform image segmentation. For instance, the ISP 112 may utilize a neural network designed for semantic segmentation tasks, such as a convolutional neural network (CNN) architecture. In such instances, the machine learning model may be configured to generate probability maps for the first image frame 302 that indicate the likelihood of each pixel belonging to a particular object category and the ISP 112 may be configured to apply thresholding to these probability maps to produce binary masks for each object. The ISP 112 may also be configured to apply one or more post-processing techniques when determining the segmentation maps 308. In certain implementations, morphological operations such as dilation and erosion may be used to smooth the boundaries of the segmented regions, which may help close small gaps and removing isolated pixels. In additional or alternative implementations, smoothing filters, such as Gaussian blurs, may also be applied to reduce noise and improve the overall quality of the segmentation.

As one skilled in the art will appreciate, additional or alternative segmentation methods may be used to determine the segmentation maps 308. For example, the segmentation maps 308 may be determined using techniques such as edge detection algorithms (e.g., Canny edge detector), thresholding based on color or intensity, and the like.

The ISP 112 may be configured to determine scores 310 based on the exposure of the image regions defined by the segmentation maps 308 in each of the second image frames 304. In certain implementations, each segmentation map 308 may have corresponding scores determined for each of the second image frames 304. For example, if there are 4 segmentation maps representing different objects or regions (such as corresponding the sky, a building, vegetation, and a person) and 16 second image frames at different exposure levels, the ISP 112 may compute 64 scores in total (4 segmentation maps multiplied by 16 second image frames).

For example, FIG. 3D depicts a scenario 360 in which a plurality of scores are determined for a segmentation map 344 according to one aspect of the present disclosure. In particular, the segmentation map 344 corresponds to the sky, and 16 images 362, 364, 366, 367, 368 (only a subset of which are depicted) that correspond to different exposure levels are scored based on the quality of the exposure. These scores are shown in the plot 370 in FIG. 3E, with the highest score for the third image (e.g., corresponding to image 364). This process may be repeated across multiple images for multiple segmentation maps (such as each of the segmentation maps 344, 346, 348, 350) to produce separate scores for each of the segmentation maps, shown in plot 372 in FIG. 3E. As can be seen in plot 372, different segmentation maps have different images with the best exposure scores.

The scores 310 may be determined to indicate a quality of exposure within the image regions defined by the segmentation maps. For example, the score 310 for each respective segmentation map and respective second image frame indicates a measure of exposure of the image regions relative to a reference intensity level.

Determining each score may involve calculating an intensity measure (such as the average intensity I_{avg}) of the image regions defined by the respective segmentation map within the respective second image frame. For example, the ISP 112 may be configured to compute I_{avg} by summing the intensity values of all pixels within the segmented region and dividing by the total number of pixels in that region.

In certain implementations, the score may be determined based on the deviation of the average intensity I_{avg} from a reference intensity level I_{ref}. For example, the scores 310 may be determined as:

$$E = exp ( - \frac{{( {I}_{avg} - {I}_{ref} )}^{2}}{2 {σ}^{2}} )$$

where:
E is the exposure score for the image region in the respective second image frame,
I_{avg} is the average intensity of the image region, normalized between 0 and 1,
I_{ref} is the reference intensity level, and
σ is a sensitivity parameter to deviations from the reference intensity level, which may be configured or may be determined based on the standard deviation of intensity values in the images.

In certain implementations, the reference intensity level I_{ref} may be configured as about 0.5, which may prioritize exposure of mid-tones in the resulting output image. In certain implementations, typical values for σ may be around 0.2. A smaller a may result in the score being more sensitive to deviations from I_{ref}, while a larger a may produce a flatter response curve, making the score less sensitive to variations in I_{avg}.

In additional or alternative implementations, different functions may be used for scoring the exposure of image regions. For example, the ISP 112 may be configured to determine scores using linear functions, sigmoid functions, other exponential functions, or combinations thereof.

The ISP 112 may be configured to determine a plurality of weights 312 corresponding to at least the subset of the second image frames 304. In certain implementations, determining the weights 312 involves calculating various types of weights for each respective second image frame 304, such as a contrast weight, a saturation weight, an exposure weight, a saliency weight, a categorical weight, or combinations thereof.

In certain implementations, the contrast weight for each respective second image frame 304 may be determined based on a measure of local contrast within the respective second image frame 304. The contrast weight may accordingly emphasize regions with high local contrast, which often correspond to important details and edges in the image. To determine the contrast weight, the ISP 112 may apply a Laplacian filter to the luminance component of each second image frame 304.

In certain implementations, the saturation weight for each respective second image frame 304 may be determined based on a measure of color saturation within the respective second image frame 304. The saturation weight may accordingly highlight regions with rich color information, enhancing the vibrancy of the output image 314. To determine the saturation weight, the ISP 112 may calculate the standard deviation of the color channel intensities at each pixel within the respective second image frame 304.

In certain implementations, the exposure weight for each respective second image frame 304 may be determined based on a measure of how close pixel intensities within the respective second image frame 304 are to a desired exposure level. The exposure weight may accordingly favor pixels that are neither underexposed nor overexposed, promoting balanced exposure in the output image 314. To determine the exposure weight, the ISP 112 may apply a Gaussian function centered at the desired exposure level to the intensity values of pixels within the respective second image frame 304.

In certain implementations, the saliency weight for each respective second image frame 304 may be determined based on a measure of visual importance of regions within the respective second image frame 304. The saliency weight may accordingly emphasizes regions that are likely to draw the viewer's attention, such as prominent objects or areas of interest. To determine the saliency weight, the ISP 112 may calculate a local average of the contrast weight using a predefined kernel size, such as the contrast weight determined above. In various implementations, the kernel size may be 2×2, 3×3, 4×4, and the like.

In certain implementations, the categorical weight for each respective second image frame 304 may be determined based on categories of regions identified in the segmentation maps 308. The categorical weight may accordingly allow the ISP 112 to prioritize scores assigned to for a particular segmentation map 308 To determine the categorical weight W_{categorical}, the ISP 112 may assign weights to pixels within the respective second image frame 304 based on the categories of regions identified in the segmentation maps 308. For example, the categorical weight may be determined as:

$${W}_{categorical} ( i , j ) = \{ \text{} \begin{matrix}{w}_{cat} , & m ( i , j ) = 1 \\ {w}_{not \_ cat} , & m ( i , j ) = 0\end{matrix} \text{}$$

where:
W_{cat} is a higher weight value,
W_{not_cat} is a lower weight value, and
m(i, j) is the value of the corresponding segmentation map 308 at pixel (i, j).

For instance, the ISP 112 may assign a weight of 0.9 to pixels classified as a categorized object for a particular segmentation map 308 and a weight of 0.1 to pixels that are not classified as the categorized object for the particular segmentation map 308.

In certain implementations, the ISP 112 may combine the second image frames 304 by applying a weighted combination that includes at least the saliency weight, the saturation weight, the exposure weight, and the categorical weight for each corresponding second image frame 304. This weighted combination facilitates the integration of the best features from each second image frame 304 into the final output image 314. For example, after determining the individual weights 312, the ISP 112 may be configured to the weights 312 to produce a final weight map Wₜₒₜₐₗ for each second image frame 304. In certain implementations, the total weight at each pixel (i,j) may be calculated by multiplying the individual weights as:

$${W}_{total} ( i , j ) = {W}_{saturation} ( i , j ) \times {W}_{exposure} ( i , j ) \times {W}_{saliency} ( i , j ) \times {W}_{categorical} ( i , j )$$

In certain implementations, the ISP 112 may normalize the total weights across all second image frames 304, such as before determining the final weight map.

The image signal processor may be configured to determine the output image 314 by combining the second image frames 304 based on the plurality of weights 312. In certain implementations, determining the output image 314 involves performing a multi-scale image fusion using pyramid decomposition techniques based on the plurality of weights 312.

In certain implementations, the ISP 112 may perform the multi-scale image fusion by first decomposing each of the second image frames 304 into a Laplacian pyramid representation. The Laplacian pyramid is a multi-scale representation that captures image details at different spatial frequencies.

To construct the Laplacian pyramid for each second image frame 304, the ISP 112 may first generate a Gaussian pyramid. This process involves creating a series of images by successively applying a Gaussian blur and downsampling the original image at each level.

The result is a set of images with decreasing resolution and increasing smoothness, representing different frequency bands of the image.

At each level l, the ISP 112 may compute the Laplacian pyramid by calculating the difference between the Gaussian-blurred image at level l and an expanded (upsampled) version of the Gaussian-blurred image at the next lower resolution level l+1. This difference captures the high-frequency details that are lost during the downsampling process, forming the Laplacian image at level l.

The ISP 112 may also be configured to decompose the weight maps 312 into Gaussian pyramid representations to align with the Laplacian pyramid levels of the second image frames 304. For example, the Gaussian pyramid of the weights

$${W}_{k}^{l}$$

for each second image frame k may be created by applying Gaussian blurs and downsampling the weights at each level l.

In certain implementations, the ISP 112 may determine guided weights by applying guided filtering to the weights at each pyramid level using the luminance component of the second image frames 304 as a guidance image. Guided filtering may smooth the weights while preserving important edges and structures, which may reduce artifacts in the fused image. In particular implementations, the guided filtering process may involve using the luminance component

$${Y}_{k}^{l}$$

of the Gaussian pyramid for each second image frame k at level l as the guidance image. In certain implementations, the ISP 112 applies guided filtering to the weight

$${W}_{k}^{l}$$

using

$${Y}_{k}^{l} ,$$

resulting in the filtered weight [symbol] . For example, the ISP 112 may be configured to determine the filtered weights by multiplying the weight

$${W}_{k}^{l}$$

by the luminance value

$${Y}_{k}^{l} .$$

The ISP 112 may be configured to perform the fusion process at each pyramid level by combining the Laplacian pyramid representations of the second image frames 304 based on the guided weights. For example, the fused Laplacian image F^{l} at level l may be computed as:

$${F}^{l} = {\sum }_{k = 1}^{N} \text{?} \times {L}_{k}^{l}$$

where:
N is the number of second image frames 304,
[symbol] is the guided weight for the k-th image at level l, and

$${L}_{k}^{l}$$

is the Laplacian image of the k-th image at level l.

To determine the output image 314, the ISP 112 may be configured to reconstruct the fused pyramid representation by collapsing the fused Laplacian pyramid. To do so, the ISP 112 may be configured to successively expanding and adding the fused images from the top level L down to level 0. In particular, the ISP 112 may be configured to reconstruct the output image 314 by adding each fused image to the expanded version of the previously reconstructed image.

Determining the output image 314 in this way may reduce artifacts such as halos and preserve important image details by combining information at multiple scales. For instance, processing image details at various scales allows for better management of high-frequency components and transitions in the image, which may help maintain edge integrity and detail throughout the fusion process. Additionally, by using guided filtering, the weights 312 may be smoothed in a way that respects the structures in the luminance images, which may prevent the introduction of artifacts that occur in traditional methods due to abrupt changes in weights.

In certain implementations, the output image 314 may be displayed as a low dynamic range (LDR) image on a display device. In certain implementations, the output image 314 is suitable for display on standard devices with limited dynamic range, such as monitors, smartphones, or televisions. Before displaying, the ISP 112 may perform color space conversions or apply gamma corrections to adjust the image for the specific characteristics of the display device, ensuring accurate color reproduction and brightness levels.

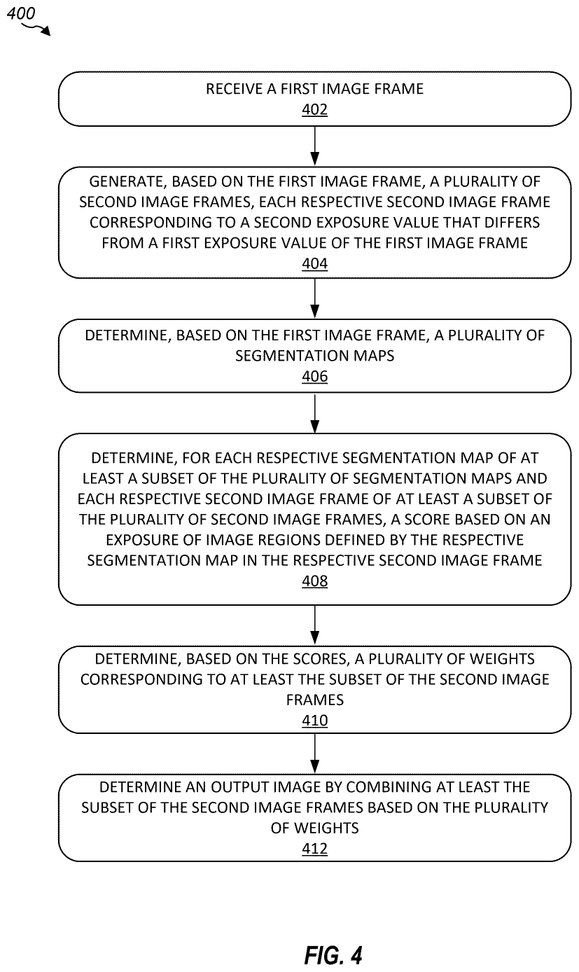

The system 200 of FIG. 2 and/or the system 300 of FIG. 3 may be configured to perform the operations described with reference to FIG. 4 to determine output image frames 230. FIG. 4 shows a flow chart of an example method 400 for processing image data to perform object aware exposure fusion according to some embodiments of the disclosure. The capturing in FIG. 4 may obtain an improved digital representation of a scene, which results in a photograph or video with higher image quality (IQ).

At block 402, the method 400 includes receiving a first image frame. For example, the ISP 112 may receive a first image frame 302. In certain implementations, the first image frame 302 may be an HDR image frame. The first image frame 302 may be captured by an imaging device, such as the camera 103, and provided to the ISP 112 for processing.

At block 404, the method 400 includes generating, based on the first image frame, a plurality of second image frames, each respective second image frame corresponding to a respective second exposure value that differs from a first exposure value of the first image frame. For example, the ISP 112 may generate a plurality of second image frames 304, each corresponding to a respective second exposure value that differs from a first exposure value of the first image frame 302. In certain implementations, generating the plurality of second image frames 304 may involve applying a plurality of tone mapping curves to the first image frame 302, each tone mapping curve corresponding to one of the second image frames 304. Each tone mapping curve may be determined by varying at least one parameter of a curve equation that defines a non-linear relationship between input pixel intensities and output pixel intensities.

At block 406, the method 400 includes determining, based on the first image frame, a plurality of segmentation maps. For example, the ISP 112 may determine a plurality of segmentation maps 308 based on the first image frame 302. In certain implementations, each segmentation map corresponds to at least one respective object of a plurality of objects within the first image frame 302, and the image regions defined by each segmentation map correspond to pixel locations of the at least one respective object.

Determining the segmentation maps 308 may involve analyzing the first image frame 302 to assign object labels to pixels within the image, each label representing one of the plurality of objects, and generating the segmentation maps based on the assigned labels.

In certain implementations, determining the segmentation maps 308 may involve using a machine learning model trained to perform image segmentation, such as a neural network.

At block 408, the method 400 includes determining, for each respective segmentation map of at least a subset of the plurality of segmentation maps and each respective second image frame of at least a subset of the plurality of second image frames, a score based on an exposure of image regions defined by the respective segmentation map in the respective second image frame. For example, the ISP 112 may determine scores 310 for each respective segmentation map of at least a subset of the segmentation maps 308 and each respective second image frame of at least a subset of the second image frames 304, based on an exposure of image regions defined by the respective segmentation map in the respective second image frame. In certain implementations, the score for each respective segmentation map and respective second image frame indicates a measure of exposure of image regions defined by the respective segmentation map in the respective second image frame relative to a reference intensity level. Determining each score may involve determining an measure of intensity of the image regions defined by the respective segmentation map within the respective second image frame and determining the score by applying a function that measures the deviation of the measure of intensity from the reference intensity level. The function may be a Gaussian function centered at the reference intensity level.

At block 410, the method 400 includes determining, based on the scores, a plurality of weights corresponding to at least the subset of the second image frames. For example, the ISP 112 may determine a plurality of weights 312 based on the scores 310, corresponding to at least the subset of the second image frames 304. In certain implementations, determining the plurality of weights 312 comprises determining, for at least the subset of the second image frames 304, at least one of a contrast weight, a saturation weight, an exposure weight, a saliency weight, a categorical weight, or a combination thereof. The contrast weight for each respective second image frame may be determined based on a measure of local contrast within the respective second image frame. Determining the contrast weight may involve applying a Laplacian filter to a luminance component of the respective second image frame to determine the measure of local contrast. The saturation weight for each respective second image frame may be determined based on a measure of color saturation within the respective second image frame. Determining the saturation weight may involve determining the measure of color saturation as a standard deviation of color channel intensities at each pixel within the respective second image frame. The exposure weight for each respective second image frame may be determined based on a measure of deviation of pixel intensities within the respective second image frame from a desired exposure level. Determining the exposure weight may involve determining the measure of deviation of pixel intensities by applying a Gaussian function centered at the desired exposure level to intensity values of pixels within the respective second image frame. The saliency weight for each respective second image frame may be determined based on a measure of visual importance of regions within the respective second image frame. Determining the saliency weight may involve determining a local average of the contrast weight using a predefined kernel size. The categorical weight for each respective second image frame may be determined based on categories of regions identified in the segmentation maps 308. Determining the categorical weight may involve determining weights for pixels within the respective second image frame based on the categories of regions identified in the segmentation maps 308, such that pixels corresponding to certain categories are assigned higher weights than pixels corresponding to other categories.

At block 412, the method 400 includes determining an output image by combining at least the subset of the second image frames based on the plurality of weights. For example, the ISP 112 may determine an output image 314 by combining at least the subset of the second image frames 304 based on the plurality of weights 312. In certain implementations, determining the output image 314 comprises combining at least the subset of the second image frames 304 by applying a weighted combination that includes at least the saliency weight, the saturation weight, the exposure weight, and the categorical weight for each corresponding second image frame. Determining the output image 314 may involve performing a multi-scale image fusion using pyramid decomposition techniques based on the plurality of weights 312. Performing the multi-scale image fusion may include determining, for each of the second image frames 304, a Laplacian pyramid representation; determining Gaussian pyramid representations of the plurality of weights 312; determining guided weights by applying guided filtering to the weights using a luminance component of the second image frames 304 as a guidance image; combining the Laplacian pyramid representations of the second image frames 304 based on the guided weights to produce a fused pyramid representation; and determining the output image 314 by reconstructing the fused pyramid representation. Reconstructing the fused pyramid representation may involve collapsing the fused pyramid representation back into a single image frame to produce the output image 314.

In certain implementations, the method 400 further includes displaying the output image 314 as a low dynamic range image on a display device. For example, the output image 314 may be suitable for display on standard devices with limited dynamic range, such as monitors or smartphones.

In one or more aspects, techniques for supporting image processing may include additional aspects, such as any single aspect or any combination of aspects described below or in connection with one or more other processes or devices described elsewhere herein. In a first aspect, a system includes a memory and a processor coupled to the memory. The processor may be configured to receive a first image frame; generate, based on the first image frame, a plurality of second image frames where each respective second image frame corresponds to a respective second exposure value that differs from a first exposure value of the first image frame; determine, based on the first image frame, a plurality of segmentation maps; determining, for each respective segmentation map of at least a subset of the plurality of segmentation maps and each respective second image frame of at least a subset of the plurality of second image frames, a score based on an exposure of image regions defined by the respective segmentation map in the respective second image frame; determine, based on the scores, a plurality of weights corresponding to at least the subset of the second image frames; and determine an output image by combining at least the subset of the second image frames based on the plurality of weights.

Additionally, the system may perform or operate according to one or more aspects as described below. In some implementations, the system includes a wireless device, such as a UE. In some implementations, the system includes a remote server, such as a cloud-based computing solution, which receives image data for processing to determine output image frames. In some implementations, the system may include at least one processor, and a memory coupled to the processor. The processor may be configured to perform operations described herein with respect to the system. In some other implementations, the system may include a non-transitory computer-readable medium having program code recorded thereon and the program code may be executable by a computer for causing the computer to perform operations described herein with reference to the system. In some implementations, the system may include one or more means configured to perform operations described herein. In some implementations, a method of wireless communication may include one or more operations described herein with reference to the system.

In a second aspect according to the first aspect, the processor is further configured, when determining the plurality of second image frames to apply a plurality of tone mapping curves to the first image frame, each tone mapping curve corresponding to one of the second image frames.

In a third aspect according to the second aspect, the plurality of tone mapping curves are determined by varying at least one parameter of a curve equation that defines a non-linear relationship between input pixel intensities and output pixel intensities.

In a fourth aspect according to any one of the first through third aspects, the score for each respective segmentation map and respective second image frame indicates a measure of exposure of image regions defined by the respective segmentation map in the respective second image frame relative to a reference intensity level.

In a fifth aspect according to the fourth aspect, the processor is further configured, when determining each score, to determine an measure of intensity of the image regions defined by the respective segmentation map within the respective second image frame, and determining the score based on deviation of the measure of intensity from the reference intensity level.

In a sixth aspect according to any one of the first through fifth aspects, the processor is further configured, when determining the plurality of weights, to determine, for at least the subset of the second image frames, at least one of a contrast weight, a saturation weight, an exposure weight, a saliency weight, a categorical weight, or a combination thereof.

In a seventh aspect according to the sixth aspect, the processor is further configured, when determining the output image, to combine at least the subset of the second image frames by applying a weighted combination that includes at least the saliency weight, the saturation weight, the exposure weight, and the categorical weight for each corresponding second image frame.

In an eighth aspect according to any one of the sixth or seventh aspects, the contrast weight for each respective second image frame is determined based on a measure of local contrast within the respective second image frame.

In a ninth aspect according to any one of the sixth through eighth aspects, the saturation weight for each respective second image frame is determined based on a measure of color saturation within the respective second image frame.

In a tenth aspect according to any one of the sixth through ninth aspects, the exposure weight for each respective second image frame is determined based on a measure of deviation of pixel intensities within the respective second image frame from a desired exposure level.

In an eleventh aspect according to any one of the sixth through tenth aspects, the processor is further configured, when determining the saliency weight, to determine a local average of the contrast weight using a predefined kernel size.

In a twelfth aspect according to any one of the sixth through eleventh aspects, the categorical weight for each respective second image frame is determined based on categories of regions identified in the plurality of segmentation maps.

In a thirteenth aspect according to any one of the first through twelfth aspects, the processor is further configured, when determining the output image, to perform a multi-scale image fusion using pyramid decomposition techniques based on the plurality of weights.

In a fourteenth aspect according to the thirteenth aspect, the processor is further configured, when performing the multi-scale image fusion, to determine, for each of the second image frames, a Laplacian pyramid representation; determine Gaussian pyramid representations of the plurality of weights; determine guided weights by applying guided filtering to the weights using a luminance component of the second image frames as a guidance image; determine a fused pyramid representation by combining the Laplacian pyramid representations of the second image frames based on the guided weights; and determine the output image by reconstructing the fused pyramid representation.

In a fifteenth aspect according to the fourteenth aspect, the processor is further configured, when reconstructing the fused pyramid representation, to collapse the fused pyramid representation back to produce the output image.

In a sixteenth aspect according to any one of the first through fifteenth aspects, the processor is further configured to display the output image on a display device.

In a seventeenth aspect, a method is provided that includes receiving a first image frame; generating, based on the first image frame, a plurality of second image frames where each respective second image frame corresponds to a respective second exposure value that differs from a first exposure value of the first image frame; determining, based on the first image frame, a plurality of segmentation maps; determining, for each respective segmentation map of at least a subset of the plurality of segmentation maps and each respective second image frame of at least a subset of the plurality of second image frames, a score based on an exposure of image regions defined by the respective segmentation map in the respective second image frame; determining, based on the scores, a plurality of weights corresponding to at least the subset of the second image frames; and determining an output image by combining at least the subset of the second image frames based on the plurality of weights.

In an eighteenth aspect according to the seventeenth aspect, determining the plurality of second image frames includes applying a plurality of tone mapping curves to the first image frame, each tone mapping curve corresponding to one of the second image frames.

In a nineteenth aspect according to the seventeenth aspect, determining the output image includes performing a multi-scale image fusion using pyramid decomposition techniques based on the plurality of weights.

In a twentieth aspect, a non-transitory computer-readable medium stores instructions which, when executed by a processor, cause the processor to perform operations including receiving a first image frame; generating, based on the first image frame, a plurality of second image frames where each respective second image frame corresponds to a respective second exposure value that differs from a first exposure value of the first image frame; determining, based on the first image frame, a plurality of segmentation maps; determining, for each respective segmentation map of at least a subset of the plurality of segmentation maps and each respective second image frame of at least a subset of the plurality of second image frames, a score based on an exposure of image regions defined by the respective segmentation map in the respective second image frame; determining, based on the scores, a plurality of weights corresponding to at least the subset of the second image frames; and determining an output image by combining at least the subset of the second image frames based on the plurality of weights.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3A include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 4 may be combined with one or more blocks (or operations) described with reference to another of the figures. For example, one or more blocks (or operations) of FIG. 4 may be combined with one or more blocks (or operations) of FIGS. 1-3A.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof.

Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium.

Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation.

Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure.

Thus, the disclosure is not intended to be limited to the examples and designs described herein, but is to be accorded the widest scope consistent with the principles and novel features disclosed herein.

What is claimed is:

1. A system comprising:
a memory; and
a processor coupled to the memory, the processor configured to:
receive a first image frame;
generate, based on the first image frame, a plurality of second image frames, each respective second image frame corresponding to a respective second exposure value that differs from a first exposure value of the first image frame;
determine, based on the first image frame, a plurality of segmentation maps;
determine, for each respective segmentation map of at least a subset of the plurality of segmentation maps and each respective second image frame of at least a subset of the plurality of second image frames, a score based on an exposure of image regions defined by the respective segmentation map in the respective second image frame;
determine, based on the scores, a plurality of weights corresponding to at least the subset of the second image frames; and
determine an output image by combining at least the subset of the second image frames based on the plurality of weights.

2. The system of claim 1, wherein the processor is further configured, when determining the plurality of second image frames, to apply a plurality of tone mapping curves to the first image frame, each tone mapping curve corresponding to one of the second image frames.

3. The system of claim 2, wherein the plurality of tone mapping curves are determined by varying at least one parameter of a curve equation that defines a non-linear relationship between input pixel intensities and output pixel intensities.

4. The system of claim 1, wherein the score for each respective segmentation map and respective second image frame indicates a measure of exposure of image regions defined by the respective segmentation map in the respective second image frame relative to a reference intensity level.

5. The system of claim 4, wherein the processor is further configured, when determining each score, to:
determine a measure of intensity of the image regions defined by the respective segmentation map within the respective second image frame; and
determine the score based on deviation of the measure of intensity from the reference intensity level.

6. The system of claim 1, wherein the processor is further configured, when determining the plurality of weights, to determine, for at least the subset of the second image frames, at least one of a contrast weight, a saturation weight, an exposure weight, a saliency weight, a categorical weight, or a combination thereof.

7. The system of claim 6, wherein the processor is further configured, when determining the output image, to combine at least the subset of the second image frames by applying a weighted combination that includes at least the saliency weight, the saturation weight, the exposure weight, and the categorical weight for each corresponding second image frame.

8. The system of claim 6, wherein the contrast weight for each respective second image frame is determined based on a measure of local contrast within the respective second image frame.

9. The system of claim 6, wherein the saturation weight for each respective second image frame is determined based on a measure of color saturation within the respective second image frame.

10. The system of claim 6, wherein the exposure weight for each respective second image frame is determined based on a measure of deviation of pixel intensities within the respective second image frame from a desired exposure level.

11. The system of claim 6, wherein the processor is further configured, when determining the saliency weight to determine a local average of the contrast weight using a predefined kernel size.

12. The system of claim 6, wherein the categorical weight for each respective second image frame is determined based on categories of regions identified in the plurality of segmentation maps.

13. The system of claim 1, wherein the processor is further configured, when determining the output image, to perform a multi-scale image fusion using pyramid decomposition techniques based on the plurality of weights.

14. The system of claim 13, wherein the processor is further configured, when performing the multi-scale image fusion, to:
determine, for each of the second image frames, a Laplacian pyramid representation;
determine Gaussian pyramid representations of the plurality of weights;
determine guided weights by applying guided filtering to the weights using a luminance component of the second image frames as a guidance image;
determine a fused pyramid representation by combining the Laplacian pyramid representations of the second image frames based on the guided weights; and
determine the output image by reconstructing the fused pyramid representation.

15. The system of claim 14, wherein the processor is further configured, when reconstructing the fused pyramid representation, to collapse the fused pyramid representation back to produce the output image.

16. The system of claim 1, wherein the processor is further configured to display the output image on a display device.

17. A method comprising:
receiving a first image frame;
generating, based on the first image frame, a plurality of second image frames, each respective second image frame corresponding to a respective second exposure value that differs from a first exposure value of the first image frame;
determining, based on the first image frame, a plurality of segmentation maps;
determining, for each respective segmentation map of at least a subset of the plurality of segmentation maps and each respective second image frame of at least a subset of the plurality of second image frames, a score based on an exposure of image regions defined by the respective segmentation map in the respective second image frame;
determining, based on the scores, a plurality of weights corresponding to at least the subset of the second image frames; and
determining an output image by combining at least the subset of the second image frames based on the plurality of weights.

18. The method of claim 17, wherein determining the plurality of second image frames comprises applying a plurality of tone mapping curves to the first image frame, each tone mapping curve corresponding to one of the second image frames.

19. The method of claim 17, wherein determining the output image comprises performing a multi-scale image fusion using pyramid decomposition techniques based on the plurality of weights.

20. A non-transitory, computer-readable medium storing instructions which, when executed by a processor, cause the processor to perform operations, comprising:
receiving a first image frame;
generating, based on the first image frame, a plurality of second image frames, each respective second image frame corresponding to a respective second exposure value that differs from a first exposure value of the first image frame;
determining, based on the first image frame, a plurality of segmentation maps;
determining, for each respective segmentation map of at least a subset of the plurality of segmentation maps and each respective second image frame of at least a subset of the plurality of second image frames, a score based on an exposure of image regions defined by the respective segmentation map in the respective second image frame;
determining, based on the scores, a plurality of weights corresponding to at least the subset of the second image frames; and
determining an output image by combining at least the subset of the second image frames based on the plurality of weights.
